(19) United States
(12) Patent Application Publication
(10) Pub. No.: US 2020/0055035 A1
(43) Pub. Date: Feb. 20, 2020

(54) EXHAUST GAS TREATMENT CATALYST FOR ABATEMENT OF NITROGEN OXIDES

(71) Applicants: BASF Corporation, Florham Park, NJ (US); N. E. CHEMCAT CORPORATION, Tokoy (JP)

(72) Inventors: Xiaolai Zheng, Princeton Junction, NJ (US); Mahmuda Choudhury, Brooklyn, NY (US); Patrick Burk, Freehold, NJ (US); Makoto Nagata, Tokyo (JP); Yasuharu Kanno, Tokyo (JP); Hiroki Nakayama, Tokyo (JP)

(73) Assignees: BASF Corporation, Florham Park, NJ (US); N. E. CHEMCAT CORPORATION, Tokoy (JP)

(21) Appl. No.: 16/487,447

(22) PCT Filed: Feb. 21, 2018
(86) PCT No.: PCT/IB2018/051076

§ 371 Date: Aug. 21, 2019

Related U.S. Application Data
(60) Provisional application No. 62/462,151, filed on Feb. 22, 2017.

(51) Int. Cl. B01J 29/85; B01J 29/76; B01J 35/04; B01J 37/02; B01D 53/94; F01N 3/10

(52) U.S. Cl. CPC B01J 29/85; F01N 2250/12; B01J 35/04; B01J 37/0215; B01D 53/9418; B01D 53/9445; B01D 53/9422; B01D 53/9477; F01N 3/101; B01D 2255/50; B01D 2255/20738; B01D 2255/20761; B01D 2255/911; B01D 2255/9155; B01J 29/76

(57) ABSTRACT

The invention provides a selective catalytic reduction (SCR) catalyst effective in the abatement of nitrogen oxides (NOx), the SCR catalyst comprising a metal-promoted molecular sieve promoted with a metal selected from iron, copper, and combinations thereof, wherein the metal is present in an amount of 2.6% by weight or less on an oxide basis based on the total weight of the metal-promoted molecular sieve. A catalyst article, an exhaust gas treatment system method, and a method treating an exhaust gas stream, each comprising the SCR catalyst of the invention, are also provided. The SCR catalyst is particularly useful for treatment of exhaust from a lean burn gasoline engine.

### TECHNICAL FIELD OF THE INVENTION

The present invention relates generally to the field of gasoline exhaust gas treatment catalysts, particularly catalysts capable of reducing NOₓ in engine exhaust.

### BACKGROUND OF THE INVENTION

Exhaust gas from vehicles powered by gasoline engines is typically treated with one or more three-way conversion (TWC) automotive catalysts, which are effective to abate nitrogen oxides (NOₓ), carbon monoxide (CO), and hydrocarbon (HC) pollutants in the exhaust of engines operated at or near stoichiometric air/fuel conditions. The precise proportion of air to fuel which results in stoichiometric conditions varies with the relative proportions of carbon and hydrogen in the fuel. An air-to-fuel (A/F) ratio is the mass ratio of air to fuel present in a combustion process such as in an internal combustion engine. The stoichiometric A/F ratio corresponds to the complete combustion of a hydrocarbon fuel, such as gasoline, to carbon dioxide (CO₂) and water. The symbol λ is thus used to represent the result of dividing a particular A/F ratio by the stoichiometric A/F ratio for a given fuel, so that: λ=1 is a stoichiometric mixture, λ>1 is a fuel-lean mixture, and λ<1 is a fuel-rich mixture.

Conventional gasoline engines having electronic fuel injection and air intake systems provide a constantly varying air-fuel mixture that quickly and continually cycles between lean and rich exhaust. Recently, to improve fuel-economy, gasoline-fueled engines are being designed to operate under lean conditions. “Lean conditions” refers to maintaining the ratio of air to fuel in the combustion mixtures supplied to such engines above the stoichiometric ratio so that the resulting exhaust gases are “lean,” i.e., the exhaust gases are relatively high in oxygen content. Lean burn gasoline direct injection (GDI) engines offer fuel efficiency benefits that can contribute to a reduction in greenhouse gas emissions by carrying out fuel combustion in excess air.

Exhaust gas from vehicles powered by lean burn gasoline engines is typically treated with a TWC catalyst, which is effective to abate CO and HC pollutants in the exhaust of engines operated under lean conditions. Emission of NOₓ also must be reduced to meet emission regulation standards. TWC catalysts, however, are not effective for reducing NOₓ emissions when the gasoline engine runs lean. Two of the most promising technologies for reducing NOₓ are ammonia selective catalytic reduction (SCR) catalysts and lean NOₓ traps (LNT). The use of certain SCR catalysts for lean burn gasoline engines presents a challenge as such catalysts are expected to exhibit thermal stability at high temperature under transient lean/rich conditions. There is a continuing need in the art for SCR catalysts effective to abate NOₓ emissions from lean burn gasoline engines while also exhibiting sufficient high temperature thermal stability.

### SUMMARY OF THE INVENTION

The invention provides a selective catalytic reduction (SCR) catalyst effective in the abatement of nitrogen oxides (NOₓ), wherein the SCR catalyst comprising a metal-promoted molecular sieve promoted with a metal selected from iron, copper, and combinations thereof, wherein the metal is present in an amount of 2.6% by weight or less on an oxide basis based on the total weight of the metal-promoted molecular sieve. It has been determined that a reduced metal loading on the molecular sieve can enhance thermal stability of the SCR catalyst after high temperature lean/rich aging. In certain embodiments, the metal is present in an amount of about 2.0% by weight or less, or about 1.8% by weight or less, or about 1.5% by weight or less. For example, the metal can be present in an amount of about 0.5% to about 2.5% by weight or about 0.5% to about 1.8% by weight. In certain embodiments, the metal is copper.

The molecular sieve of the SCR catalyst can be, for example, a small pore molecular sieve having a maximum ring size of eight tetrahedral atoms and a double six-ring (d6r) unit. In some embodiments, the molecular sieve is a zeolite, such as a zeolite having a structure type selected from the group consisting of AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof. In some embodiments, the structure type is CHA. The molecular sieve can have a molar ratio of silica to alumina (SAR) in various ranges, such as about 5 to about 100.

In certain embodiments, the SCR catalyst exhibits a NOₓ conversion of about 60% or greater at 300° C. after a thermal aging treatment, wherein the thermal aging treatment is conducted at 850° C. for 5 hours under cyclic lean/rich conditions in the presence of 10% steam, the lean/rich aging cycle consisting of 5 minutes of air, 5 minutes of N₂, 5 minutes of 4% H₂ balanced with N₂, and 5 minutes of N₂, with these four steps repeated until the aging duration is reached. In addition, certain embodiments of the SCR catalyst exhibit a NH₃ storage of at least about 0.60 g/L or greater at 200° C. after the above-noted thermal aging treatment.

In another aspect, the invention provides a catalyst article effective to abate nitrogen oxides (NOₓ) from a lean burn gasoline engine exhaust gas, the catalyst article comprising a substrate carrier having a catalyst composition disposed thereon, wherein the catalyst composition comprises the SCR catalyst of any embodiment of the invention. Exemplary substrate carriers include honeycomb substrates, which can be constructed of, for example, metal or ceramic. Exemplary honeycomb substrate carriers include a flow-through substrate or a wall flow filter. The catalyst composition can be applied to the substrate carrier in the form of a washcoat, and the washcoat can include additional materials such as a binder selected from silica, alumina, titania, zirconia, ceria, or a combination thereof.

Still further, the invention includes an exhaust gas treatment system comprising a lean burn gasoline engine that produces an exhaust gas stream and a catalyst article of any inventive embodiment positioned downstream from the lean burn gasoline engine and in fluid communication with the exhaust gas stream. The exhaust gas treatment system can further include, for example, at least one of a three-way conversion catalyst (TWC) and a lean NOx trap (LNT) (wherein one or both of the TWC and the LNT are in a close-coupled position) positioned downstream from the lean burn gasoline engine and upstream of the SCR catalyst.

In yet another aspect, the invention provides a method of treating an exhaust gas stream from a lean burn gasoline engine, comprising contacting the exhaust gas stream with a catalyst article comprising a substrate carrier having a catalyst composition disposed thereon, wherein the catalyst composition comprises the SCR catalyst of any inventive embodiment, such that nitrogen oxides (NOx) in the exhaust gas stream are abated.

The present disclosure includes, without limitation, the following embodiments.

Embodiment 1: A selective catalytic reduction (SCR) catalyst effective in the abatement of nitrogen oxides (NOₓ), the SCR catalyst comprising a metal-promoted molecular sieve promoted with a metal selected from iron, copper, and combinations thereof, wherein the metal is present in an amount of 2.6% by weight or less on an oxide basis based on the total weight of the metal-promoted molecular sieve.

Embodiment 2: The SCR catalyst of any preceding embodiment, wherein the metal is present in an amount of about 2.0% by weight or less.

Embodiment 3: The SCR catalyst of any preceding embodiment, wherein the metal is present in an amount of about 1.8% by weight or less.

Embodiment 4: The SCR catalyst of any preceding embodiment, wherein the metal is present in an amount of about 1.5% by weight or less.

Embodiment 5: The SCR catalyst of Embodiment 1, wherein the metal is present in an amount of about 0.5% to about 2.5% by weight.

Embodiment 6: The SCR catalyst of any one of Embodiments 1-3 or 5, wherein the metal is present in an amount of about 0.5% to about 1.8% by weight.

Embodiment 7: The SCR catalyst of any preceding embodiment, wherein the metal is copper.

Embodiment 8: The SCR catalyst of any preceding embodiment, wherein the molecular sieve is a small pore molecular sieve having a maximum ring size of eight tetrahedral atoms and a double six-ring (d6r) unit.

Embodiment 9: The SCR catalyst of any preceding embodiment, wherein the molecular sieve is a zeolite.

Embodiment 10: The SCR catalyst of any preceding embodiment, wherein the zeolite has a structure type selected from the group consisting of AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof.

Embodiment 11: The SCR catalyst of any preceding embodiment, wherein the structure type is CHA.

Embodiment 12: The SCR catalyst of any preceding embodiment, wherein the molecular sieve has a molar ratio of silica to alumina (SAR) of about 5 to about 100.

Embodiment 13: The SCR catalyst of any preceding embodiment, wherein the SCR catalyst exhibits a NOₓ conversion of about 60% or greater at 300° C. after a thermal aging treatment, wherein the thermal aging treatment is conducted at 850° C. for 5 hours under cyclic lean/rich conditions in the presence of 10% steam, the lean/rich aging cycle consisting of 5 minutes of air, 5 minutes of N₂, 5 minutes of 4% H₂ balanced with N₂, and 5 minutes of N₂, with these four steps repeated until the aging duration is reached.

Embodiment 14: The SCR catalyst of any preceding embodiment, wherein the SCR catalyst exhibits a NH₃ storage of at least about 0.60 g/L or greater at 200° C. after a thermal aging treatment, wherein the thermal aging treatment is conducted at 850° C. for 5 hours under cyclic lean/rich conditions in the presence of 10% steam, the lean/rich aging cycle consisting of 5 minutes of air, 5 minutes of N₂, 5 minutes of 4% H₂ balanced with N₂, and 5 minutes of N₂, with these four steps repeated until the aging duration is reached.

Embodiment 15: A catalyst article effective to abate nitrogen oxides (NOₓ) from a lean burn gasoline engine exhaust gas, the catalyst article comprising a substrate carrier having a catalyst composition disposed thereon, wherein the catalyst composition comprises the SCR catalyst of any preceding embodiment.

Embodiment 16: The catalyst article of any preceding embodiment, wherein the substrate carrier is a honeycomb substrate.

Embodiment 17: The catalyst article of any preceding embodiment, wherein the honeycomb substrate is metal or ceramic.

Embodiment 18: The catalyst article of any preceding embodiment, wherein the honeycomb substrate carrier is a flow-through substrate or a wall flow filter.

Embodiment 19: The catalyst article of any preceding embodiment, wherein the catalyst composition is applied to the substrate carrier in the form of a washcoat, the washcoat further comprising a binder selected from silica, alumina, titania, zirconia, ceria, or a combination thereof.

Embodiment 20: An exhaust gas treatment system comprising: a lean burn gasoline engine that produces an exhaust gas stream; a catalyst article positioned downstream from the lean burn gasoline engine and in fluid communication with the exhaust gas stream, the catalyst article effective to abate nitrogen oxides (NOₓ) from the exhaust gas stream, the catalyst article comprising a substrate carrier having a catalyst composition disposed thereon, wherein the catalyst composition comprises the SCR catalyst of any preceding embodiment.

Embodiment 21: The exhaust gas treatment system of any preceding embodiment, further comprising at least one of a three-way conversion catalyst (TWC) and a lean NOx trap (LNT) positioned downstream from the lean burn gasoline engine and upstream of the SCR catalyst.

Embodiment 22: The exhaust gas treatment system of any preceding embodiment, wherein one or both of the TWC and the LNT are in a close-coupled position.

Embodiment 23: A method of treating an exhaust gas stream from a lean burn gasoline engine, comprising: contacting the exhaust gas stream with a catalyst article comprising a substrate carrier having a catalyst composition disposed thereon, wherein the catalyst composition comprises the SCR catalyst of any preceding embodiment, such that nitrogen oxides (NOx) in the exhaust gas stream are abated.

Embodiment 24: The method of any preceding embodiment, further comprising contacting the exhaust gas stream with one or more catalyst articles comprising at least one of a three-way conversion catalyst (TWC) and a lean NOx trap (LNT) positioned downstream from the lean burn gasoline engine and upstream of the SCR catalyst.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1A is a perspective view of a honeycomb-type substrate which may comprise a catalyst composition in accordance with the present invention;

FIG. 1B is a partial cross-sectional view enlarged relative to FIG. 1A and taken along a plane parallel to the end faces of the carrier of FIG. 1A, which shows an enlarged view of a plurality of the gas flow passages shown in FIG. 1A;

FIG. 2 shows a cross-sectional view of a section of a wall flow filter substrate;

FIG. 3 shows a schematic depiction of an embodiment of an emission treatment system in which a catalyst of the present invention is utilized;

FIG. 4 is a bar graph showing BET surface areas after air aging and lean/rich aging for samples prepared according to the Examples;

FIG. 5 graphically illustrates light-off test results of SCR catalysts as set forth in the Examples; and

FIG. 6 is a bar graph showing NH₃ storage capacity of SCR catalysts as set forth in the Examples.

### DETAILED DESCRIPTION OF THE INVENTION

Before describing several exemplary embodiments of the invention, it is to be understood that the invention is not limited to the details of construction or process steps set forth in the following description. The invention is capable of other embodiments and of being practiced or being carried out in various ways.

With respect to the terms used in this disclosure, the following definitions are provided. As used in this specification and the appended claims, the singular forms “a,” “an,” and “the” include plural referents unless the context clearly indicates otherwise. Thus, for example, reference to “a catalyst” includes a mixture of two or more catalysts, and the like.

As used herein, the term “abate” means to decrease in amount and “abatement” means a decrease in the amount, caused by any means.

As used herein, the term “gasoline engine” refers to any internal combustion engine with spark-ignition designed to run on gasoline. Recently, to improve fuel-economy, gasoline-fueled engines are being designed to operate under lean conditions. “Lean conditions” refers to maintaining the ratio of air to fuel in the combustion mixtures supplied to such engines above the stoichiometric ratio so that the resulting exhaust gases are “lean,” i.e., the exhaust gases are relatively high in oxygen content (λ>1). Lean burn gasoline direct injection (GDI) engines, for example, offer fuel efficiency benefits that can contribute to a reduction in greenhouse gas emissions by carrying out fuel combustion in excess air. In one or more embodiments, the engine is selected from a stoichiometric gasoline engine or a lean burn gasoline direct injection engine.

As used herein, the term “stream” broadly refers to any combination of flowing gas that may contain solid or liquid particulate matter. The term “gaseous stream” or “exhaust gas stream” means a stream of gaseous constituents, such as the exhaust of an engine, which may contain entrained non-gaseous components such as liquid droplets, solid particulates, and the like. The exhaust gas stream of an engine typically further comprises combustion products, products of incomplete combustion, oxides of nitrogen, combustible and/or carbonaceous particulate matter (soot), and un-reacted oxygen and nitrogen.

As used herein, the terms “refractory metal oxide support” and “support” refer to the underlying high surface area material upon which additional chemical compounds or elements are carried. The support particles typically have pores larger than 20 Å and a wide pore distribution. As defined herein, such refractory metal oxide supports exclude molecular sieves, specifically, zeolites. In particular embodiments, high surface area refractory metal oxide supports can be utilized, e.g., alumina support materials, also referred to as “gamma alumina” or “activated alumina,” which typically exhibit a BET surface area in excess of 60 square meters per gram (“m²/g”), often up to about 200 m²/g or higher. Such activated alumina is usually a mixture of the gamma and delta phases of alumina, but may also contain substantial amounts of eta, kappa, and theta alumina phases. Refractory metal oxides other than activated alumina can be used as a support for at least some of the catalytic components in a given catalyst. For example, bulk ceria, zirconia, alpha alumina, silica, titania, and other materials are known for such use.

As used herein, the term “BET surface area” has its usual meaning of referring to the Brunauer, Emmett, Teller method for determining surface area by N₂ adsorption. Pore diameter and pore volume can also be determined using BET-type N₂ adsorption or desorption experiments.

As used herein, the term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions. Examples of oxygen storage components include rare earth oxides, particularly ceria, lanthana, praseodymia, neodymia, niobia, europia, samaria, ytterbia, yttria, zirconia, and mixtures thereof.

The term “base metal” refers generally to a metal that oxidizes or corrodes relatively easily when exposed to air and moisture. In one or more embodiments, the base metal comprises one or more base metal oxides selected from vanadium (V), tungsten (W), titanium (Ti), copper (Cu), iron (Fe), cobalt (Co), nickel (Ni), chromium (Cr), manganese (Mn), neodymium (Nd), barium (Ba), cerium (Ce), lanthanum (La), praseodymium (Pr), magnesium (Mg), calcium (Ca), zinc (Zn), niobium (Nb), zirconium (Zr), molybdenum (Mo), tin (Sn), tantalum (Ta), and strontium (Sr), or combinations thereof.

As used herein, the term “platinum group metal” or “PGM” refers to one or more chemical elements defined in the Periodic Table of Elements, including platinum, palladium, rhodium, osmium, iridium, and ruthenium, and mixtures thereof.

Certain SCR catalyst with high loadings of promoter metal exhibit poor thermal stability under rich/lean cycling conditions. Without intending to be bound by theory, it is thought that instability of, for example, high Cu- and/or Fe-loaded SCR catalysts is due to the proximity of Cu(II) and/or Fe(III) cations in the zeolitic micropores, which are subjected to reduction to form metallic Cu and/or metallic Fe nanoparticles under rich aging conditions at a high temperature. Under lean conditions, those metallic Cu and/or metallic Fe species are oxidized to CuO and/or Fe₂O₃ in an agglomerated form instead of site-isolated Cu and/or Fe cations. As a result, the zeolitic structure continuously loses Cu and/or Fe cation species and eventually collapses. Surprisingly, it was found that catalysts comprising a relatively low Cu and/or Fe loading display a higher thermal stability under lean/rich aging, particularly at high temperatures (e.g., 850° C.).

Thus, according to embodiments of a first aspect of the invention, a catalyst effective to abate NOₓ from a gasoline engine exhaust gas is provided, the catalyst comprising a metal-promoted molecular sieve promoted with a metal selected from iron, copper, and combinations thereof, wherein the metal is present in an amount of 2.6% by weight or less on an oxide basis based on the total weight of the metal-promoted molecular sieve.

As used herein, the term “selective catalytic reduction” (SCR) refers to the catalytic process of reducing oxides of nitrogen to dinitrogen (N₂) using a nitrogenous reductant. As used herein, the terms “nitrogen oxides” or “NOₓ” designate the oxides of nitrogen.

The SCR process uses catalytic reduction of nitrogen oxides with ammonia to form nitrogen and water:

4NO+4NH₃+O₂→4N₂+6H₂O (standard SCR reaction)

2NO₂+4NH₃→3N₂+6H₂O (slow SCR reaction)

NO+NO₂+2NH₃→2N₂+3H₂O (fast SCR reaction)

Catalysts employed in the SCR process ideally should be able to retain good catalytic activity over the wide range of temperature conditions of use, for example, about 200° C. to about 600° C. or higher, under hydrothermal conditions. Hydrothermal conditions are often encountered in practice, such as during the regeneration of a soot filter, a component of the exhaust gas treatment system used for the removal of particles.

The term “molecular sieve” refers to zeolites and other framework materials (e.g., isomorphously substituted materials). Molecular sieves are materials based on an extensive three-dimensional network of oxygen ions containing generally tetrahedral type sites and having a substantially uniform pore distribution, with the average pore size typically being no larger than 20 Å. The pore sizes are defined by the ring size. According to one or more embodiments, it will be appreciated that by defining the molecular sieves by their framework type, it is intended to include any and all zeolite or isotypic framework materials, such as SAPO, ALPO and MeAPO, Ge-silicates, all-silica, and similar materials having the same framework type.

Generally, molecular sieves, e.g., zeolites, are defined as aluminosilicates with open 3-dimensional framework structures composed of corner-sharing TO₄ tetrahedra, where T is Al, Si, or optionally P. Cations that balance the charge of the anionic framework are loosely associated with the framework oxygens, and the remaining pore volume is filled with water molecules. The non-framework cations are generally exchangeable, and the water molecules removable.

As used herein, the term “zeolite” refers to a specific example of a molecular sieve, including silicon and aluminum atoms. Zeolites are crystalline materials having rather uniform pore sizes which, depending upon the type of zeolite and the type and amount of cations included in the zeolite lattice, range from about 3 to 10 Angstroms in diameter. The molar ratio of silica to alumina (SAR) of zeolites, as well as other molecular sieves, can vary over a wide range, but is generally 2 or greater. In one or more embodiments, the molecular sieve has a SAR molar ratio in the range of about 2 to about 300, including about 5 to about 250; about 5 to about 200; about 5 to about 100; and about 5 to about 50. In one or more specific embodiments, the molecular sieve has a SAR molar ratio in the range of about 10 to about 200, about 10 to about 100, about 10 to about 75, about 10 to about 60, and about 10 to about 50; about 15 to about 100, about 15 to about 75, about 15 to about 60, and about 15 to about 50; about 20 to about 100, about 20 to about 75, about 20 to about 60, or about 20 to about 50.

In more specific embodiments, reference to an aluminosilicate zeolite framework type limits the material to molecular sieves that do not include phosphorus or other metals substituted in the framework. However, to be clear, as used herein, “aluminosilicate zeolite” excludes aluminophosphate materials such as SAPO, ALPO, and MeAPO materials, and the broader term “zeolite” is intended to include aluminosilicates and aluminophosphates. The term “aluminophosphates” refers to another specific example of a molecular sieve, including aluminum and phosphate atoms. Aluminophosphates are crystalline materials having rather uniform pore sizes.

In one or more embodiments, the molecular sieve, independently, comprises SiO₄/AlO₄ tetrahedra that are linked by common oxygen atoms to form a three-dimensional network. In other embodiments, the molecular sieve comprises SiO₄/AlO₄/PO₄ tetrahedra. The molecular sieve of one or more embodiments can be differentiated mainly according to the geometry of the voids which are formed by the rigid network of the (SiO₄)/AlO₄, or SiO₄/AlO₄/PO₄, tetrahedra. The entrances to the voids are formed from 6, 8, 10, or 12 ring atoms with respect to the atoms which form the entrance opening. In one or more embodiments, the molecular sieve comprises ring sizes of no larger than 12, including 6, 8, 10, and 12.

According to one or more embodiments, the molecular sieve can be based on the framework topology by which the structures are identified. Typically, any framework type of zeolite can be used, such as framework types of ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AVL, AWO, AWW, BCT, BEA, BEC, BIK, BOG, BPH, BRE, CAN, CAS, SCO, CFI, SGF, CGS, CHA, CHI, CLO, CON, CZP, DAC, DDR, DFO, DFT, DOH, DON, EAB, EDI, EEI, EMT, EON, EPI, ERI, ESV, ETR, EUO, FAU, FER, FRA, GIS, GIU, GME, GON, GOO, HEU, IFR, IFY, IHW, IRN, ISV, ITE, ITH, ITW, IWR, IWW, JBW, KFI, LAU, LEV, LIO, LIT, LOS, LOV, LTA, LTL, LTN, MAR, MAZ, MEI, MEL, MEP, MER, MFI, MFS, MON, MOR, MOZ, MSO, MTF, MTN, MTT, MTW, MWF, MWW, NAB, NAT, NES, NON, NPO, NPT, NSI, OBW, OFF, OSI, OSO, OWE, PAR, PAU, PHI, PON, RHO, RON, RRO, RSN, RTE, RTH, RUT, RWR, RWY, SAO, SAS, SAT, SAV, SBE, SBS, SBT, SFE, SFF, SFG, SFH, SFN, SFO, SFW, SGT, SOD, SOS, SSY, STF, STI, STT, TER, THO, TON, TSC, UEI, UFI, UOZ, USI, UTL, VET, VFI, VNI, VSV, WIE, WEN, YUG, ZON, or combinations thereof.

In one or more embodiments, the molecular sieve comprises an 8-ring small pore aluminosilicate zeolite. As used herein, the term “small pore” refers to pore openings which are smaller than about 5 Angstroms, for example on the order of ˜3.8 Angstroms. The phrase “8-ring” zeolites refers to zeolites having 8-ring pore openings and double-six ring secondary building units and having a cage like structure resulting from the connection of double six-ring building units by 4 rings. In one or more embodiments, the molecular sieve is a small pore molecular sieve having a maximum ring size of eight tetrahedral atoms.

Zeolites are comprised of secondary building units (SBU) and composite building units (CBU), and appear in many different framework structures. Secondary building units contain up to 16 tetrahedral atoms and are non-chiral. Composite building units are not required to be achiral, and cannot necessarily be used to build the entire framework. For example, a group of zeolites have a single 4-ring (s4r) composite building unit in their framework structure. In the 4-ring, the “4” denotes the positions of tetrahedral silicon and aluminum atoms, and the oxygen atoms are located in between tetrahedral atoms. Other composite building units include, for example, a single 6-ring (s6r) unit, a double 4-ring (d4r) unit, and a double 6-ring (d6r) unit. The d4r unit is created by joining two s4r units. The d6r unit is created by joining two s6r units. In a d6r unit, there are twelve tetrahedral atoms. Exemplary zeolitic framework types used in certain embodiments include AEI, AFT, AFX, AFV, AVL, CHA, DDR, EAB, EEI, EMT, ERI, FAU, GME, IFY, IRN, JSR, KFI, LEV, LTA, LTL, LTN, MER, MOZ, MSO, MWF, MWW, NPT, OFF, PAU, RHO, RTE, RTH, SAS, SAT, SAV, SBS, SBT, SFW, SSF, SZR, TSC, UFI, and WEN. In certain advantageous embodiments, the zeolitic framework is selected from AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof. In other specific embodiments, the molecular sieve has a framework type selected from the group consisting of CHA, AEI, AFX, ERI, KFI, LEV, and combinations thereof. In still further specific embodiments, the molecular sieve has a framework type selected from CHA, AEI, and AFX. In one or more very specific embodiments, the molecular sieve has the CHA framework type.

Zeolitic CHA-framework type molecular sieves include a naturally occurring tectosilicate mineral of a zeolite group with approximate formula: (Ca,Na₂,K₂,Mg)Al₂Si₄O₁₂.6H₂O (e.g., hydrated calcium aluminum silicate). Three synthetic forms of zeolitic CHA-framework type molecular sieves are described in “Zeolite Molecular Sieves,” by D. W. Breck, published in 1973 by John Wiley & Sons, which is hereby incorporated by reference. The three synthetic forms reported by Breck are Zeolite K-G, described in J. Chem. Soc., p. 2822 (1956), Barrer et al; Zeolite D, described in British Patent No. 868,846 (1961); and Zeolite R, described in U.S. Pat. No. 3,030,181, which are hereby incorporated by reference. Synthesis of another synthetic form of zeolitic CHA framework type, SSZ-13, is described in U.S. Pat. No. 4,544,538, which is hereby incorporated by reference. Synthesis of a synthetic form of a molecular sieve having the CHA framework type, silicoaluminophosphate 34 (SAPO-34), is described in U.S. Pat. Nos. 4,440,871 and 7,264,789, which are hereby incorporated by reference. A method of making yet another synthetic molecular sieve having the CHA framework type, SAPO-44, is described in U.S. Pat. No. 6,162,415, which is hereby incorporated by reference.

As noted above, in one or more embodiments, the molecular sieve can include all aluminosilicate, borosilicate, gallosilicate, MeAPSO, and MeAPO compositions. These include, but are not limited to SSZ-13, SSZ-62, natural chabazite, zeolite K-G, Linde D, Linde R, LZ-218, LZ-235. LZ-236, ZK-14, SAPO-34, SAPO-44, SAPO-47, ZYT-6, CuSAPO-34, CuSAPO-44, Ti-SAPO-34, and CuSAPO-47.

As used herein, the term “promoted” refers to a component that is intentionally added to the molecular sieve material, as opposed to impurities inherent in the molecular sieve. Thus, a promoter is intentionally added to enhance activity of a catalyst compared to a catalyst that does not have promoter intentionally added. In order to promote the selective catalytic reduction of nitrogen oxides in the presence of ammonia, in one or more embodiments, a suitable metal(s) is independently exchanged into the molecular sieve. According to one or more embodiments, the molecular sieve is promoted with copper (Cu) and/or iron (Fe). In specific embodiments, the molecular sieve is promoted with copper (Cu). In other embodiments, the molecular sieve is promoted with copper (Cu) and iron (Fe). In still further embodiments, the molecular sieve is promoted with iron (Fe).

Surprisingly, it was found that low promoter metal content leads to catalysts that are highly stable under lean/rich aging conditions at temperatures of 800° C. and above, particularly 850° C. and above. In one or more embodiments, the promoter metal content of the catalyst, calculated as the oxide of the metal, is present in an amount of 2.6% by weight or less, based on the total weight of the metal-promoted molecular sieve, such as embodiments wherein the metal is present in an amount of about 2.5% by weight or less, about 2.3% by weight or less, about 1.8% by weight or less, about 1.5% by weight or less, about 1.2% by weight or less, or about 1.0% by weight or less. Exemplary ranges for metal content include about 0.5% to about 2.5% by weight or about 0.5% to about 1.8% by weight. In one or more embodiments, the promoter metal content is reported on a volatile free basis.

In certain embodiments, the metal-promoted molecular sieve of the invention exhibits surprisingly strong hydrothermal stability at high temperature, such as after a thermal aging treatment conducted at 850° C. for 5 hours under cyclic lean/rich conditions (lean/rich aging) in the presence of 10% steam, the lean/rich aging cycle consisting of 5 minutes of air, 5 minutes of N₂, 5 minutes of 4% H₂ balanced with N₂, and 5 minutes of N₂, with these four steps repeated until aging duration is reached. In particular, it has been determined that embodiments of the invention exhibit surprisingly strong SCR performance and NH₃ storage performance after the above-noted aging treatment. For example, after such an aging treatment, certain embodiments of the metal-promoted molecular sieve of the invention provide NOx conversion of about 60% or greater at 300° C. (e.g., about 65% or greater, about 70% or greater, or about 75% or greater at 300° C.). Still further, after such an aging treatment, certain embodiments of the metal-promoted molecular sieve of the invention provide NH₃ storage of at least about 0.60 g/L or greater at 200° C. (e.g., about 0.65 g/L or greater, about 0.70 g/L or greater or about 0.75 g/L or greater at 200° C.).

### Substrate

In one or more embodiments, the catalyst composition of the invention is disposed on a substrate. As used herein, the term “substrate” refers to the monolithic material onto which the catalyst material is placed, typically in the form of a washcoat. A washcoat is formed by preparing a slurry containing a specified solids content (e.g., 30-90% by weight) of catalyst in a liquid, which is then coated onto a substrate and dried to provide a washcoat layer. As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated.

The washcoat containing the metal-promoted molecular sieve of the invention can optionally comprise a binder selected from silica, alumina, titania, zirconia, ceria, or a combination thereof. The loading of the binder is typically about 0.1 to 10 wt. % based on the weight of the washcoat.

In one or more embodiments, the substrate is selected from one or more of a flow-through honeycomb monolith or a particulate filter, and the catalytic material(s) are applied to the substrate as a washcoat.

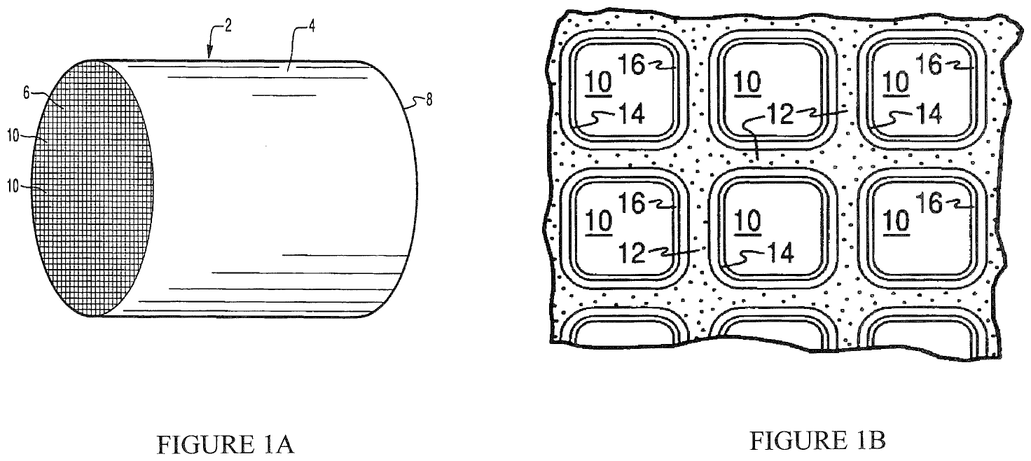

FIGS. 1A and 1B illustrate an exemplary substrate 2 in the form of a flow-through substrate coated with a catalyst composition as described herein. Referring to FIG. 1A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 1B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 1B, walls 12 are so dimensioned and configured that gas flow passages 10 have a substantially regular polygonal shape. As shown, the catalyst composition can be applied in multiple, distinct layers if desired. In the illustrated embodiment, the catalyst composition consists of both a discrete bottom layer 14 adhered to the walls 12 of the carrier member and a second discrete top layer 16 coated over the bottom layer 14. The present invention can be practiced with one or more (e.g., 2, 3, or 4) catalyst layers and is not limited to the two-layer embodiment illustrated in FIG. 1B.

In one or more embodiments, the substrate is a ceramic or metal having a honeycomb structure. Any suitable substrate may be employed, such as a monolithic substrate of the type having fine, parallel gas flow passages extending there through from an inlet or an outlet face of the substrate such that passages are open to fluid flow there through. The passages, which are essentially straight paths from their fluid inlet to their fluid outlet, are defined by walls on which the catalytic material is coated as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from about 60 to about 900 or more gas inlet openings (i.e., cells) per square inch of cross section.

A ceramic substrate may be made of any suitable refractory material, e.g., cordierite, cordierite-α-alumina, silicon nitride, zircon mullite, spodumene, alumina-silica-magnesia, zircon silicate, sillimanite, a magnesium silicate, zircon, petalite, α-alumina, an aluminosilicate and the like. Substrates useful for the catalyst of embodiments of the present invention may also be metallic in nature and be composed of one or more metals or metal alloys. A metallic substrate may include any metallic substrate, such as those with openings or “punch-outs” in the channel walls. Metallic substrates may be employed in various shapes such as pellets, corrugated sheet or monolithic form. Specific examples of metallic substrates include the heat-resistant, base-metal alloys, especially those in which iron is a substantial or major component. Such alloys may contain one or more of nickel, chromium, and aluminum, and the total of these metals may advantageously comprise at least about 15 wt. % of the alloy, for instance, about 10 to 25 wt. % chromium, about 1 to 8 wt. % of aluminum, and about 0 to 20 wt. % of nickel, in each case based on the weight of the substrate.

In one or more embodiments in which the substrate is a particulate filter, the particulate filter can be selected from a gasoline particulate filter or a soot filter. As used herein, the terms “particulate filter” or “soot filter” refer to a filter designed to remove particulate matter from an exhaust gas stream such as soot. Particulate filters include, but are not limited to honeycomb wall flow filters, partial filtration filters, wire mesh filters, wound fiber filters, sintered metal filters, and foam filters. In a specific embodiment, the particulate filter is a catalyzed soot filter (CSF). The catalyzed CSF comprises, for example, a substrate coated with a catalyst composition of the invention for oxidizing NO to NO₂.

Wall flow substrates useful for supporting the catalyst material of one or more embodiments have a plurality of fine, substantially parallel gas flow passages extending along the longitudinal axis of the substrate. Typically, each passage is blocked at one end of the substrate body, with alternate passages blocked at opposite end-faces. Such monolithic substrates may contain up to about 900 or more flow passages (or “cells”) per square inch of cross section, although far fewer may be used. For example, the substrate may have from about 7 to 600, more usually from about 100 to 400, cells per square inch (“cpsi”). The porous wall flow filter used in embodiments of the invention can be catalyzed in that the wall of said element has thereon or contained therein a platinum group metal. Catalytic materials may be present on the inlet side of the substrate wall alone, the outlet side alone, both the inlet and outlet sides, or the wall itself may consist all, or in part, of the catalytic material. In another embodiment, this invention may include the use of one or more catalyst layers and combinations of one or more catalyst layers on the inlet and/or outlet walls of the substrate.

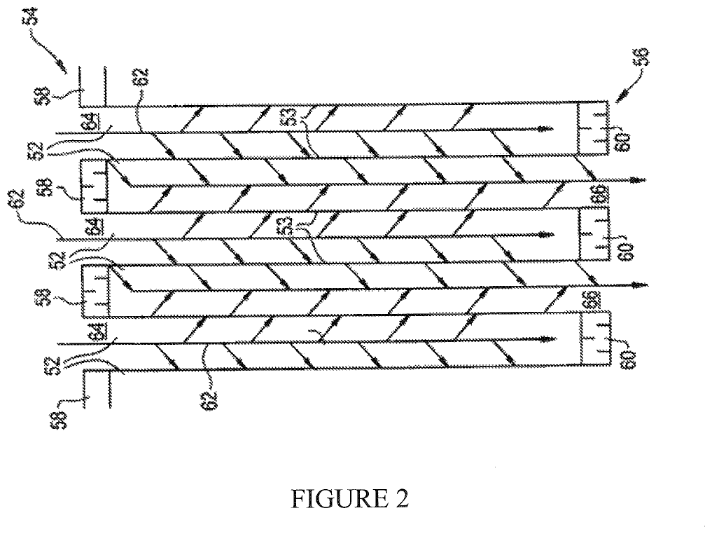

As seen in FIG. 2, an exemplary substrate has a plurality of passages 52. The passages are tubularly enclosed by the internal walls 53 of the filter substrate. The substrate has an inlet end 54 and an outlet end 56. Alternate passages are plugged at the inlet end with inlet plugs 58, and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in the invention can be catalyzed in that the wall of the substrate has thereon one or more catalytic materials.

### Exhaust Gas Treatment System

A further aspect of the present invention is directed to an exhaust gas treatment system. In one or more embodiments, an exhaust gas treatment system comprises a gasoline engine, particularly a lean burn gasoline engine, and the catalyst composition of the invention downstream from the engine.

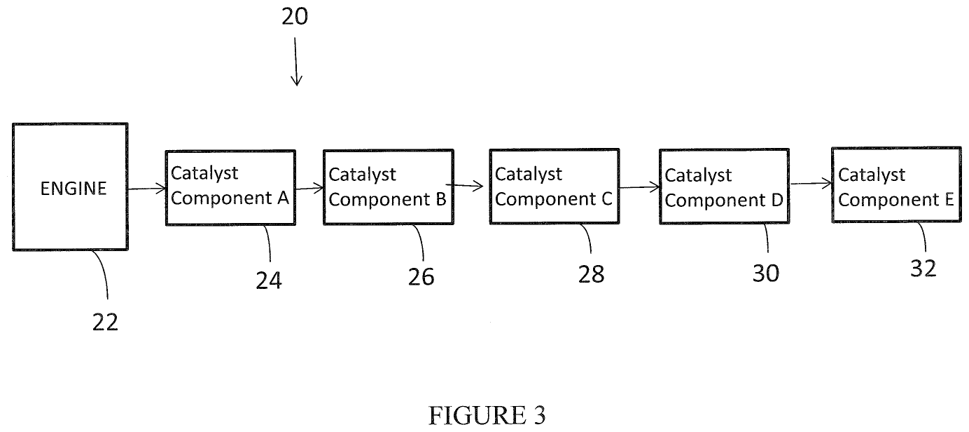

One exemplary emission treatment system is illustrated in FIG. 3, which depicts a schematic representation of an emission treatment system 20. As shown, the emission treatment system can include a plurality of catalyst components in series downstream of an engine 22, such as a lean burn gasoline engine. At least one of the catalyst components will be the SCR catalyst of the invention as set forth herein. The catalyst composition of the invention could be combined with numerous additional catalyst materials and could be placed at various positions in comparison to the additional catalyst materials. FIG. 3 illustrates five catalyst components, 24, 26, 28, 30, 32 in series; however, the total number of catalyst components can vary and five components is merely one example.

Without limitation, Table 1 presents various exhaust gas treatment system configurations of one or more embodiments. It is noted that each catalyst is connected to the next catalyst via exhaust conduits such that the engine is upstream of catalyst A, which is upstream of catalyst B, which is upstream of catalyst C, which is upstream of catalyst D, which is upstream of catalyst E (when present). The reference to Components A-E in the table can be cross-referenced with the same designations in FIG. 3.

The TWC catalyst noted in Table 1 can be any catalyst conventionally used to abate carbon monoxide (CO) and hydrocarbon (HC) pollutants in the exhaust gas of engines, as well as capable of oxidation of nitrogen oxides (NOₓ) under certain conditions, and will typically comprise a platinum group metal (PGM) supported on an oxygen storage component (e.g., ceria) and/or a refractory metal oxide support (e.g., alumina). The TWC catalyst can also include a base metal component impregnated on a support.

The LNT catalyst noted in Table 1 can be any catalyst conventionally used as a NOₓ trap, and typically comprises NOₓ-adsorber compositions that include base metal oxides (BaO, MgO, CeO₂, and the like) and a platinum group metal for catalytic NO oxidation and reduction (e.g., Pt and Rh).

Reference to TWC-LNT in the table refers to a catalyst composition with both TWC and LNT functionality (e.g., having TWC and LNT catalyst compositions in either a layered format or a randomly mixed format on a substrate).

Reference to SCR in the table refers to an SCR catalyst, which can include the SCR catalyst composition of the invention. Reference to SCRoF (or SCR on filter) refers to a particulate or soot filter (e.g., a wall flow filter), which can include the SCR catalyst composition of the invention. Where both SCR and SCRoF are present, one or both can include the SCR catalyst of the invention, or one of the catalysts could include a conventional SCR catalyst (e.g., SCR catalyst with conventional metal loading level).

Reference to FWC™ (or four-way catalyst) in the table refers to trade name for a BASF catalyst that combines a TWC catalyst with a particulate filter (e.g., a wall flow filter).

Reference to AMOx in the table refers to an ammonia oxidation catalyst, which can be provided downstream of the catalyst of one more embodiments of the invention to remove any slipped ammonia from the exhaust gas treatment system. In specific embodiments, the AMOx catalyst may comprise a PGM component. In one or more embodiments, the AMOx catalyst may comprise a bottom coat with PGM and a top coat with SCR functionality.

As recognized by one skilled in the art, in the configurations listed in Table 1, any one or more of components A, B, C, D, or E can be disposed on a particulate filter, such as a wall flow filter, or on a flow-through honeycomb substrate. In one or more embodiments, an engine exhaust system comprises one or more catalyst compositions mounted in a position near the engine (in a close-coupled position, CC), with additional catalyst compositions in a position underneath the vehicle body (in an underfloor position, UF). For example, in certain embodiments, one or both of the TWC and LNT are in a CC position and the remaining components are UF.

TABLE 1

| Compo- | Compo- | Compo- | Compo- | Compo- |
|---|---|---|---|---|
| nent A | nent B | nent C | nent D | nent E |
| TWC | LNT | SCR | Optional AMOx | — |
| TWC | LNT | SCRoF | Optional AMOx | — |
| TWC | LNT | SCRoF | SCR | Optional AMOx |
| TWC | LNT | FWC | SCR | Optional AMOx |
| TWC | TWC-LNT | SCR | Optional AMOx | — |

### Method of Treating Engine Exhaust

Another aspect of the present invention is directed to a method of treating the exhaust gas stream of a gasoline engine, particularly a lean burn gasoline engine. The method can include placing the catalyst according to one or more embodiments of the invention downstream from a gasoline engine and flowing the engine exhaust gas stream over the catalyst. In one or more embodiments, the method further comprising placing additional catalyst components downstream from the engine as noted above.

The invention is now described with reference to the following examples. Before describing several exemplary embodiments of the invention, it is to be understood that the invention is not limited to the details of construction or process steps set forth in the following description. The invention is capable of other embodiments and of being practiced or being carried out in various ways.

### EXAMPLES

### Example 1

### Comparative

3.2% CuO Cu-SSZ-13: To a vessel equipped with a mechanical agitator and steam heating was added a suspension of NH₄⁺-exchanged SSZ-13 with a silica-to-alumina ratio of 30. The vessel contents were heated to 60° C. under agitation. A solution of copper acetate was added to the reaction mixture. The solid was filtered, washed with deionized water, and air-dried. The resulting Cu-SSZ-13 was calcined in air at 550° C. for 6 hours. The obtained product has a copper content of 3.2 wt. %, on the basis of CuO as determined by ICP analysis.

### Example 2

2.4% CuO Cu-SSZ-13: Following the preparation procedure of Example 1, Cu-SSZ-13 with a copper content of 2.4 wt. %, on the basis of CuO as determined by ICP analysis, was obtained.

### Example 3

1.7% CuO Cu-SSZ-13: Following the preparation procedure of Example 1, Cu-SSZ-13 with a copper content of 1.7 wt. %, on the basis of CuO as determined by ICP analysis, was obtained.

### Example 4

1.1% CuO Cu-SSZ-13: Following the preparation procedure of Example 1, Cu-SSZ-13 with a copper content of 1.1 wt. %, on the basis of CuO as determined by ICP analysis, was obtained.

### Example 5

0.6% CuO Cu-SSZ-13: Following the preparation procedure of Example 1, Cu-SSZ-13 with a copper content of 0.6 wt. %, on the basis of CuO as determined by ICP analysis, was obtained.

### Example 6

1.7% CuO CuSAPO-34: Following the preparation procedure of Example 3 and NH₄⁺-SAPO-34 as the precursor, CuSAPO-34 of a copper content of 1.7 wt. %, on the basis of CuO as determined by ICP analysis, was obtained.

### Example 7

### Aging and Testing

Powder samples were aged in a horizontal tube furnace fit with a quartz tube. Aging was carried out at 850° C. for 5 hours under either a flow of air (air aging) or cyclic lean/rich conditions (lean/rich aging) in the presence of 10% steam. In the case of the lean/rich aging, the aging cycle includes 5 minutes of air, 5 minutes of N₂, 5 minutes of 4% H₂ balanced with N₂, and 5 minutes of N₂; such a cycle is repeated till the desired aging duration is reached.

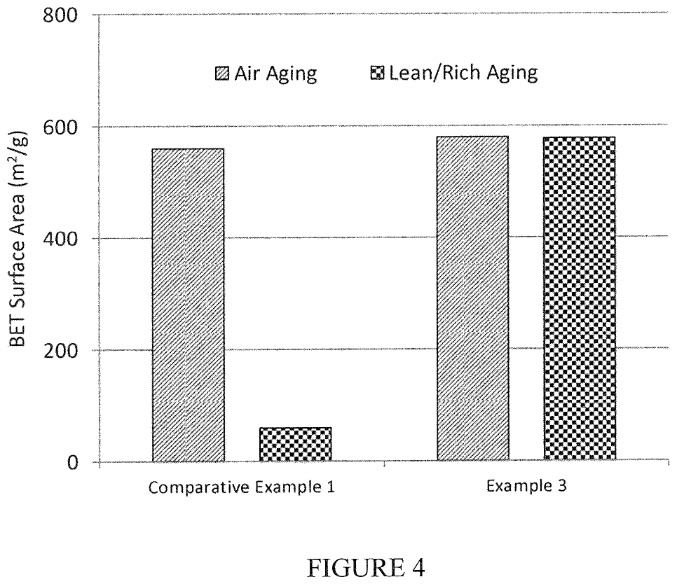

FIG. 4 provides a comparison of BET surface areas between Comparative Example 1 and Example 3 after air aging and lean/rich aging at 850° C. for 5 hours. Comparative Example 1 contained 3.2% CuO, a loading typical for diesel applications. Example 3 contained 1.7% CuO which was significantly lower than Comparative Example 1. Under air aging conditions, both examples retained a BET surface area of >550 m²/g. However, under lean/rich aging conditions, a significant deterioration in BET surface area was observed for Comparative Example 1. In contrast, Example 3 retained a surface area comparable to the air-aged sample under lean/rich aging conditions. Table 2 summarizes BET surface areas of Cu-SSZ-13 and CuSAPO-34 of different CuO loadings after lean/rich aging. It is clearly shown that the lower CuO loadings are critical for the high thermal stability under lean/rich aging conditions, which are more relevant to gasoline engine (e.g., lean GDI) applications. As can be seen from the data in Table 2, copper loadings of less than about 2.0% by weight or less than about 1.8% by weight are particularly advantageous as the BET surface area remains virtually unchanged after aging when such copper loadings are utilized.

TABLE 2

| | | CuO Loading | BET Surface Area |
|---|---|---|---|
| | Zeolite | (wt. %)^{a} | After Aging (m²/g)^{b} |
| Comp. Ex. 1 | SSZ-13 | 3.2 | 65 |
| Ex. 2 | SSZ-13 | 2.4 | 278 |
| Ex. 3 | SSZ-13 | 1.7 | 578 |
| Ex. 4 | SSZ-13 | 1.1 | 583 |
| Ex. 5 | SSZ-13 | 0.6 | 586 |
| Ex. 6 | SAPO-34 | 1.7 | 569 |

^{a}Cu content on the basis of CuO determined by ICP.
^{b}Lean/rich aging at 850° C. for 5 hours as noted above.

### Example 8

Three Cu-CHA catalyst slurries are coated onto 1.0″(diameter)×3.0″(length) cylinder monolith substrates, having a cell density of 400 cpsi (number of cells per square inch) and a wall thickness of 4 mil. The three catalysts have different CuO loadings as set forth in Table 3 below. The coated substrates were flashed dried on a flow-through drier at 200° C. and calcined at 450° C. for 2 hours.

TABLE 3

| Catalyst | Cu-CHA CuO Loading | Washcoat Loading, g/in³ |
|---|---|---|
| A | 3.2 wt. % | 3.0 g/in³ |
| B | 2.4 wt. % | 3.5 g/in³ |
| C | 1.7 wt. % | 3.5 g/in³ |

The three SCR catalysts were aged at 850° C. for 5 hours under lean/rich conditions on a horizontal lab reactor as described in Example 7. The SCR performance and NH₃ storage capacity were evaluated on a lab reactor equipped with a gas manifold, gas cylinders and mass-flow controllers, a water pump and vaporizer, a vertical tube furnace, a sample holder, a lambda sensor, thermocouples, and a MKS MultiGas FT-IR Analyzer. The two test protocols are as follows:
i) SCR light-off test: 500 ppm NO, 550 ppm NH₃, 5% H₂O, 5% CO₂, 10% O₂, balanced with N₂, space velocity (SV)=60K hr⁻¹, T=150-490° C.
ii) NH₃ storage test: Adsorption: 500 ppm NH₃, 5% H₂O, 5% CO₂, 10% O₂, SV=60K hr⁻¹, T=200° C.; Desorption: T=200-490° C.

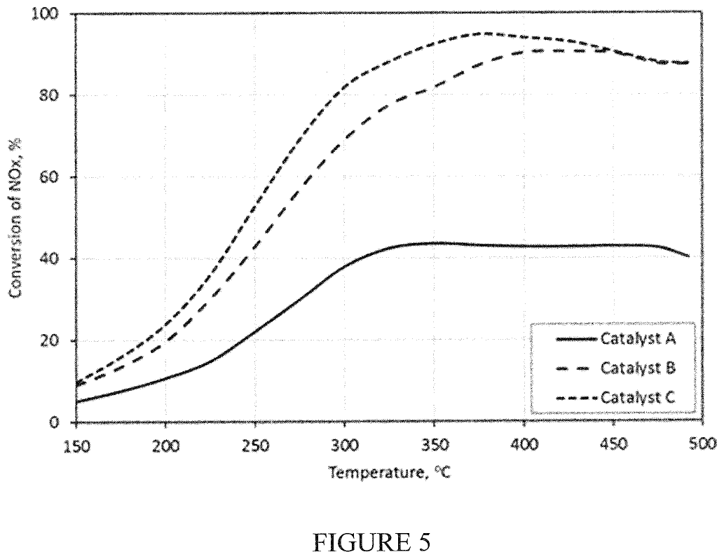

The SCR light-off test results are plotted in FIG. 5. The conventional 3.2% Cu-CHA Catalyst A gave a low NOx conversion of ˜40% at temperatures of 300° C. or greater, indicating that the SCR component was substantially degraded under the given aging conditions. In contrast, Catalysts B and C with reduced copper content significantly outperformed Catalyst A after the same aging treatment. The SCR activity of the catalyst with the lowest copper loading provided the best SCR activity. This data suggests that lower CuO loading is desired for gasoline SCR applications, particularly lean burn gasoline engine applications.

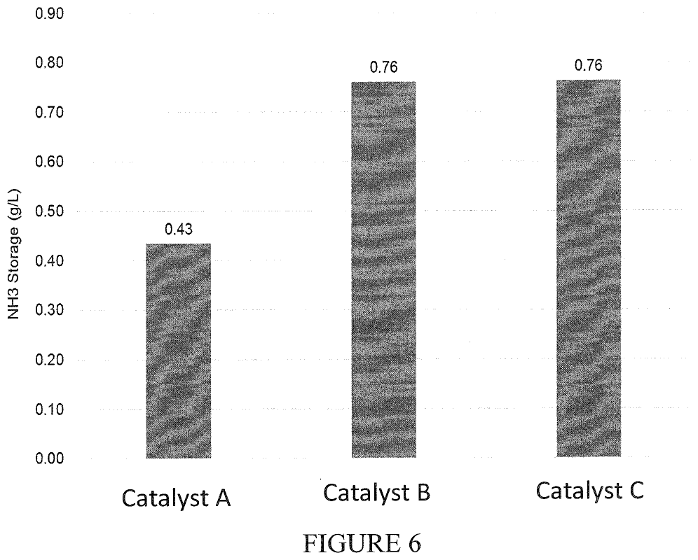

The NH₃ storage test results are illustrated in FIG. 6. The two catalysts with the lower CuO loading displayed comparable NH₃ storage capacity in the temperature-programmed desorption process. Catalyst A, although having a higher CuO loading, showed much lower storage capacity due to degradation.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A selective catalytic reduction (SCR) catalyst effective in the abatement of nitrogen oxides (NOₓ), the SCR catalyst comprising a metal-promoted molecular sieve promoted with a metal selected from iron, copper, and combinations thereof, wherein the metal is present in an amount of 2.6% by weight or less on an oxide basis based on the total weight of the metal-promoted molecular sieve.

2. The SCR catalyst of claim 1, wherein the metal is present in an amount of about 2.0% by weight or less.

3.-4. (canceled)

5. The SCR catalyst of claim 1, wherein the metal is present in an amount of about 0.5% to about 2.5% by weight.

6. (canceled)

7. The SCR catalyst of claim 1, wherein the metal is copper.

8. The SCR catalyst of claim 1, wherein the molecular sieve is a small pore molecular sieve having a maximum ring size of eight tetrahedral atoms and a double six-ring (d6r) unit.

9. The SCR catalyst of claim 1, wherein the molecular sieve is a zeolite.

10. The SCR catalyst of claim 9, wherein the zeolite has a structure type selected from the group consisting of AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI, and combinations thereof.

11. (canceled)

12. The SCR catalyst of claim 1, wherein the molecular sieve has a molar ratio of silica to alumina (SAR) of about 5 to about 100.

13. The SCR catalyst of claim 1, wherein the SCR catalyst exhibits a NOₓ conversion of about 60% or greater at 300° C. after a thermal aging treatment, wherein the thermal aging treatment is conducted at 850° C. for 5 hours under cyclic lean/rich conditions in the presence of 10% steam, the lean/rich aging cycle consisting of 5 minutes of air, 5 minutes of N₂, 5 minutes of 4% H₂ balanced with N₂, and 5 minutes of N₂, with these four steps repeated until the aging duration is reached.

14. The SCR catalyst of claim 1, wherein the SCR catalyst exhibits a NH₃ storage of at least about 0.60 g/L or greater at 200° C. after a thermal aging treatment, wherein the thermal aging treatment is conducted at 850° C. for 5 hours under cyclic lean/rich conditions in the presence of 10% steam, the lean/rich aging cycle consisting of 5 minutes of air, 5 minutes of N₂, 5 minutes of 4% H₂ balanced with N₂, and 5 minutes of N₂, with these four steps repeated until the aging duration is reached.

15. A catalyst article effective to abate nitrogen oxides (NOₓ) from a lean burn gasoline engine exhaust gas, the catalyst article comprising a substrate carrier having a catalyst composition disposed thereon, wherein the catalyst composition comprises the SCR catalyst of claim 1.

16. The catalyst article of claim 15, wherein the substrate carrier is a honeycomb substrate.

17. The catalyst article of claim 15, wherein the honeycomb substrate is metal or ceramic.

18. The catalyst article of claim 15, wherein the honeycomb substrate carrier is a flow-through substrate or a wall flow filter.

19. The catalyst article of claim 15, wherein the catalyst composition is applied to the substrate carrier in the form of a washcoat, the washcoat further comprising a binder selected from silica, alumina, titania, zirconia, ceria, or a combination thereof.

20. An exhaust gas treatment system comprising:
a lean burn gasoline engine that produces an exhaust gas stream;
a catalyst article positioned downstream from the lean burn gasoline engine and in fluid communication with the exhaust gas stream, the catalyst article effective to abate nitrogen oxides (NOₓ) from the exhaust gas stream, the catalyst article comprising a substrate carrier having a catalyst composition disposed thereon, wherein the catalyst composition comprises the SCR catalyst of claim 1.

21. The exhaust gas treatment system of claim 20, further comprising at least one of a three-way conversion catalyst (TWC) and a lean NOx trap (LNT) positioned downstream from the lean burn gasoline engine and upstream of the SCR catalyst.

22. The exhaust gas treatment system of claim 21, wherein one or both of the TWC and the LNT are in a close-coupled position.

23. A method of treating an exhaust gas stream from a lean burn gasoline engine, comprising: contacting the exhaust gas stream with a catalyst article comprising a substrate carrier having a catalyst composition disposed thereon, wherein the catalyst composition comprises the SCR catalyst of claim 1, such that nitrogen oxides (NOx) in the exhaust gas stream are abated.

24. The method of claim 23, further comprising contacting the exhaust gas stream with one or more catalyst articles comprising at least one of a three-way conversion catalyst (TWC) and a lean NOx trap (LNT) positioned downstream from the lean burn gasoline engine and upstream of the SCR catalyst.
